(19) United States
(12) Patent Application Publication
(10) Pub. No.: US 2006/0233674 A1
(43) Pub. Date: Oct. 19, 2006

(54) Microfluidic apparatus having a vaporizer and method of using same

(76) Inventor: James Curtis Nelson, Essex (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/489,803

(22) PCT Filed: Jan. 28, 2004
(86) PCT No.: PCT/EP04/00958

§ 371 Date: Jan. 19, 2006

(30) Foreign Application Priority Data
Jan. 31, 2003 (GB) 0302302.5

(51) Int. Cl. B01L 3/00

(52) U.S. Cl. 422/101

(57) ABSTRACT

An apparatus for performing microchemistry having:—
(a) a vapour permeable microfluidic chip structure (1) having:—
   a supply conduit (11a-c) enclosed in the chip structure having first and second opposed ends to enable first and second fluid materials to interact by flowing the first and second fluid materials towards one another from the opposed ends of the supply conduit, and
   a valve mechanism (13b) in the chip structure operable to open and close the supply conduit at an intermediate position (55) located between the first and second ends thereof whereby the chip structure is sequentially movable from a filling state in which the intermediate position is closed to enable the fluid materials to be blind-filled in the supply conduit on opposed sides of the intermediate position and an interaction state in which the intermediate position is open to enable the fluid materials to interact; and
(b) a vaporizer (100) for forming a vaporous environment about the chip structure to compensate for evaporation of the fluid materials from the supply conduit of the chip structure in the interaction state.

### RELATED APPLICATION

The present patent application claims priority from UK patent application No. 0302302.5 filed on 31 Jan. 2003, the entire content of which is hereby incorporated herein by reference.

### FIELD OF THE INVENTION

The present invention relates to a microfluidic apparatus and method and is particularly, but not exclusively, concerned with improvements in protein crystallisation in a microfluidic chip.

### BACKGROUND OF THE INVENTION

A microfluidic chip for performing protein crystallisation has been developed by Fluidigm Corporation (www.fluidigm.com) as part of the Topaz™ system. This chip is discussed in the paper ‘A Robust and Scalable Microfluidic Metering Method that allows Protein Crystal Growth by Free Interface Diffusion’. Hansen et al. Proceedings of the National Academy of Sciences of the United States (PNAS), Vol. 99, No. 26, 2002, p. 16531-16536.

This microfluidic chip is fabricated by a technique referred to as “Multi-Layer Soft Lithography” (or MSL™) to result in a laminate structure having a lower glass layer in which an array of wells of different volumes is formed in an upper face thereof, and a water vapour permeable, inert elastomeric upper layer having a lower face sealingly laid on the upper face of the glass layer. The lower face of the elastomeric layer has an array of fluid grooves formed therein, each fluid groove forming a fluid supply conduit with the adjoining glass layer and intersecting a plurality of the wells. The elastomeric layer also includes an array of valves in the form of control conduits which are spaced upwardly of the fluid grooves and arranged to cross-over a plurality of the supply conduits. By pressurising the control conduits hydraulically, the control conduits are deformed (i.e. radially expanded) sufficiently in the downward direction that they cause the supply conduits they cross to close at the cross-over positions.

The conduits are arranged so that unit cells are defined thereby. That is to say, each supply conduit is crossed by three control conduits with a well being positioned between the middle control conduit and each outer control conduit of a unit cell. The outer control conduits in each unit cell are equi-spaced from the associated middle conduit, thereby resulting in different volumes on the respective sides of the middle conduit when the wells in a unit cell are of different volumes.

In use, the chip is firstly filled with the reactants by operating the middle control conduits to close the associated supply conduits and (i) pneumatically driving a protein solution into the supply conduits so that it is blind-filled into the unit cells on one side of the middle control conduit, and (ii) pneumatically driving a crystallisation reagent into each supply conduit so that it is blind-filled into the unit cells on the opposite side of the middle control conduit. Then, the outer control conduits for each unit cell are operated to close the associated supply conduits followed by the middle control conduits being de-pressurised to open the associated supply conduits. In this way, the unit cells become closed cells in which the protein solution and the crystallisation reagent are able to diffuse towards one another and, hopefully, result in protein crystals forming in some of the wells of the chip.

In the protein crystallisation reaction mode, the middle control conduits are supposed to remain open indefinitely, or for at least as long as it takes for the protein to diffuse to the reagent well and/or vice-versa. In this connection, the molecular size of the respective molecules means that the diffusion rate for the reagent is typically much greater than for the protein, e.g. for salt-based or small molecule reagent solutions, although large molecular size reagents, such as polyethylene glycols (PEGs), have a slow diffusion rate too. Thus, while it will typically only take a few hours for a fast diffusing reagent to diffuse to the protein well, it will typically take the protein days or weeks to diffuse to the reagent well (and vice-versa for slow diffusing reagents).

Noting this, it has been observed by the Applicant that the middle control conduits spontaneously re-close the supply conduits after a few hours. This means that only fast diffusing reagents have sufficient time to diffuse from the well on its side of the closed cell to the well on the protein side and/or vice-versa.

The aim of the present invention is to provide means by which this phenomena is prevented.

In this connection, the Applicant has determined that the middle control conduit re-closes due to water in the protein solution and/or crystallisation reagent evaporating from the supply conduit out of the water vapour permeable, upper layer of the chip. In other words, the chip becomes dehydrated. The evaporation process leads to a loss of pressure in the supply conduit whereby the pressure in the middle conduit becomes greater than that in the supply conduit causing it to spontaneously close again.

### SUMMARY OF THE INVENTION

According to the present invention there is provided an apparatus for performing microchemistry as set forth in claim 1 hereof.

The invention is particularly, but nor exclusively, advantageous when the valve mechanism is such that it would operate to re-close the supply conduit at the intermediate position in the interaction state if the evaporation from the chip structure was not compensated for, e.g. due to the consequent loss in pressure in the supply conduit causing the valve mechanism to re-close at the intermediate position. This would be the case where, as in the embodiment hereinafter described, the valve mechanism has a valve in the form of a control conduit enclosed in the chip structure to cross the supply conduit in spaced relation thereto at the intermediate position, the supply and control conduits being so constructed and arranged that the control conduit is able to expand at the intermediate position sufficiently to cause the supply conduit to close thereat when the pressure in the control conduit is greater than that in the supply conduit. So, unless evaporation from the supply conduit is compensated for, it creates a closing pressure difference in the supply and control conduits. As an example, if the control and supply conduits were at atmospheric pressure on initiation of the interaction state, a sub-atmospheric pressure or vacuum would be subsequently created in the supply conduit on evaporation therefrom which would cause the valve to re-close. In the filling state, the control conduit may be pressurised hydraulically or pneumatically to close the valve at the intermediate position.

Preferably, the chip structure is formed at least in part from an inert resilient material, for example an elastomeric material, preferably a silicone elastomer, e.g. such as polydimethyl siloxane (PDMS), and the supply conduit and valve mechanism are located in the resilient material. The chip structure may further include a rigid material, e.g. glass, contiguous with the resilient material, in which case the supply conduit is formed along the boundary of the resilient and rigid materials, i.e. one side of the supply conduit is presented by the resilient material and the opposite side is presented by the rigid material.

Preferably, the vaporizer forms a vaporous environment about the chip structure containing the same vapour as that evaporating from the chip structure. Typically, the vapour will be water vapour, as in the embodiment hereinafter described. In this case, the vaporizer may act like a humidor to maintain a humid local environment about the chip structure.

It will be gathered that the vaporizer acts to prevent the microfluidic chip structure from dehydrating. In other words, the vaporizer maintains the chip structure in a hydrated state. The use of the terms “dehydration”, “hydrated” and the like herein not only relates to water vapour, but may also relate to other vapours depending on the fluid being evaporated from the closed cell.

Preferably, the vaporizer is such as to saturate, or substantially saturate, the local environment about the chip structure. If the vapour is water vapour, it is preferable to achieve 90-100% Relative Humidity (RH), more preferably 95-100% RH, even more preferably 100% RH or substantially 100% RH. In an embodiment, such as hereinafter to be described, 100% RH is achieved.

In an embodiment such as the one hereinafter described, the vaporizer includes at least a part of an enclosure in which the chip structure is enclosable and further has a vapour generating mechanism for generating a vapour inside the enclosure. The at least a part of the enclosure may be a housing, as in the embodiment hereinafter described. The vapour generating mechanism may be included in the at least a part of the enclosure. The vapour generating mechanism may have a store for storing a vapourisable liquid, for instance one or more absorbent pads for absorbing the vapourisable liquid thereon.

The at least a part of the enclosure may include a window which, when the chip structure is received in the enclosure, registers with the chip structure so that the supply conduit is observable therethrough.

The enclosure may have a carrier on which the chip structure is supported. The housing of the enclosure is preferably adapted to seat on the carrier. Ideally, the housing is sealingly seatable on the carrier, for instance through a seal which sealingly engages the interfacing surfaces of the carrier and housing.

The carrier preferably also has a window which, when the chip structure is seated thereon, registers with the chip structure on an opposed side from the housing window to enable the supply conduit to be viewed from both sides of the enclosure. Thus, analysis or inspection signals, for instance light or other electromagnetic radiation, can be transmitted through the chip structure from one side of the enclosure to the other to enable the interaction of the fluid materials to be monitored, e.g. by imaging apparatus or analytical instruments.

The enclosure preferably forms a sealed or hermetic environment about the chip structure, or a substantially sealed or hermetic environment thereabout. To this end, one or more seals may be provided for the joints of the parts constituting the enclosure, e.g. as between the housing and the carrier.

Preferably the vapourisable liquid is sufficiently volatile to vapourise at the ambient experimental conditions at which the evaporation occurs, e.g. at atmospheric pressure and room temperature.

In an aspect of the invention the vaporizer includes a source of vapourisable liquid.

In another aspect of the present invention there is provided an apparatus for performing microchemistry as set forth in claim 17 hereof.

In an embodiment of the invention, the valve mechanism has a valve in the form of a control conduit enclosed in the chip structure to cross the supply conduit in spaced relation thereto at the intermediate position, the supply and control conduits are so constructed and arranged that the control conduit is able to expand at the intermediate position sufficiently to cause the supply conduit to close thereat when the pressure in the control conduit is greater than that in the supply conduit by a predetermined pressure difference, and the compensation mechanism is adapted to maintain the pressure difference between the control conduit and the supply conduit below the predetermined pressure difference in the interaction state of the chip.

In an embodiment of the invention, the compensation mechanism operates to hydrate the chip in the interaction state.

As an example, the compensation mechanism may be a vaporizer for forming a vaporous environment about the chip structure to compensate for evaporation from the chip structure in the interaction state.

The supply conduit may be one of a set of such supply conduits in the microfluidic chip structure and the valve mechanism is operable on the additional supply conduits in a corresponding manner. In this case, the control conduit of the valve of the valve mechanism may extend across the set of supply conduits, or a sub-set of the supply conduits, at the respective intermediate positions.

The valve mechanism may have one or more further valves in the form of control conduits for extending across further sets or sub-sets of the supply conduits at the respective intermediate positions.

The valve mechanism may be further operable to form a closed cell in the supply conduit which includes the intermediate position and in which the fluid materials interact in the interaction state and the vaporizer/compensation mechanism is adapted in use to compensate for evaporation of the fluid materials from the closed cell in the interaction state.

As an example, the valve mechanism in the chip structure is operable to open and close the supply conduit at first and second end positions, on opposed sides of the intermediate position, to form therebetween a closed cell in the supply conduit whereby in the filling state the end positions are open and in the interaction state the end positions are closed to enable the fluid materials to interact in the closed cell.

The valve(s) for the supply conduit(s) may be a first valve(s) and the valve mechanism may have second valves corresponding to the first valve(s) which act on the supply conduit(s) at the end positions for closure thereof.

The second valves may act on a number of different supply conduits at the corresponding end positions thereof.

Preferably, the supply conduits and control conduits are arranged in an orderly array in the chip structure.

According to a further aspect of the present invention there is provided a vaporizer for use with a microfluidic chip structure having a casing structure for placing over the chip structure and a vapour generating mechanism carried by the casing structure for generating a vaporous environment inside the casing structure about the chip.

The vapour generating mechanism is preferably mounted on an internal surface of the casing structure which, in use, faces the chip structure. The vapour generating mechanism may be releasably carried on the casing structure. The vapour generating mechanism may have a store for storing a vapourisable liquid, e.g. as in the case of an absorbent structure.

The casing structure preferably includes means for allowing inspection or analysis signals, e.g. light, to be incident on the chip when received therein, i.e. the casing structure is transparent to the signal. More preferably, the casing structure is adapted to allow the signals to be transmitted through it to allow the signal to be transmitted through the chip. As an example, the casing structure may include one or more window sections which, in use, register with the chip for viewing thereof.

The casing structure may form at least a part of an enclosure adapted to enclose the chip, for instance a lid part of the enclosure. The casing structure may include the remaining part(s) of the enclosure, for instance a carrier part for carrying the chip and on which the lid part is seatable. Preferably the casing structure forms a sealed enclosure, or substantially sealed enclosure, for the chip. As an example, the casing structure may include seals at the joints between the parts thereof.

The chip in this aspect of the invention may correspond to the chip of the apparatus of the invention.

Preferably, the apparatus/vaporizer/compensation mechanism is a manually-carriable unit. In an embodiment of the invention, such as the one hereinafter described, it is sized to fit into, and be carried by, one hand of a normally-sized adult human.

The apparatus or vaporizer of the invention may further include a vapour impermeable cover part which, in use, is placed in bearing relation on the chip surface. The cover may have one or more cut-outs therein to enable fluid connectors to be engaged with the chip surface. In an embodiment, such as the one hereinafter described, the cover part is made from glass.

According to the present invention there is further provided a method of interacting first and second fluid materials comprising the steps set out in claim 38 hereof.

The method may include a preparation step prior to the blind-filling of the supply conduit with the fluid materials in which the chip is hydrated by a vaporous environment.

The vaporous environment may be formed by the vaporizer or compensation mechanism of the invention.

The method may further include the step of decreasing the level of saturation in the vaporous environment after the first and second fluid materials have interacted for a duration sufficient to reach an equilibrium state.

Preferably, the interaction is a protein crystallisation reaction. For instance, the first fluid material is a protein solution and the second fluid material is a crystallisation reagent solution, one or both of the solutions typically being an aqueous solution.

The vaporous environment may be a sealed environment. Moreover, the vapour may be water vapour, especially for protein crystallisation, in which case the level of saturation is preferably in the range of 90-100% RH, more preferably 95-100% RH. For protein crystallisation, it may be convenient to reduce the RH level after the diffusion of the protein and reagent has reached an equilibrium state or has finished, e.g. by removing the vapourous environment. The relative concentrations of the protein and reagent in the aqueous solution thus increases aiding protein crystallisation.

Other aspects and preferred features of the invention are set forth in the claims hereof.

The present invention further provides for features from the different aspects thereof to be incorporated into one another.

Yet further preferred features are to be found in the exemplary embodiments of the present invention which will now be described with reference to the accompanying Figures of drawings.

### BRIEF DESCRIPTION OF THE FIGURES OF DRAWINGS

FIG. 1A is a schematic plan view of a microfluidic chip for protein crystallisation.

FIG. 1B is an enlarged detail from the inset I of FIG. 1A of one of the unit cells of the chip which comprises a parallel array of supply lines and a parallel array of valve control conduits arranged orthogonally to the supply conduits.

FIG. 2 is an enlarged, schematic sectional side view of the microfluidic chip along line II-II in FIG. 1A showing the spatial arrangement of the supply conduits and the valve control conduits.

FIG. 3 corresponds to FIG. 2, but shows the supply conduit closed by the valve control conduit.

FIG. 3A is an exploded perspective view of a prior art apparatus for protein crystallisation incorporating the microfluidic chip.

FIG. 4 is a photograph of a unit cell of the chip in which the supply conduits are erroneously re-closed by one of the valve control conduits after 4 hours of the crystallisation process due to dehydration of the chip when using phosphate buffered saline (PBS) as the reagent for the protein.

FIGS. 5A and 5B are graphs showing fluorescent monitoring of the reagent diffusion in the unit cell shown in FIG. 4.

FIG. 6 is a photograph showing the extent of diffusion of the protein in the unit cell of FIG. 4.

FIG. 7 is an exploded perspective view of a vaporizer in accordance with the present invention comprising a transparent housing, absorbent pads mountable inside the housing and a sealing gasket.

FIG. 8 is a underneath plan view of the vaporizer with one of the absorbent pads omitted for greater clarity.

FIG. 9 is a side sectional view of an apparatus in accordance with the invention in which the chip and vaporizer are assembled onto a chip carrier.

FIG. 10 is a photograph of a unit cell of the chip which has been maintained in a hydrated state by the vaporizer after 4 hours of a crystallisation process with the same reactants as in FIG. 4.

FIG. 11 is a photograph showing the extent of protein diffusion in the unit cell of FIG. 10.

FIG. 12 is a schematic perspective view of a glass slide which can optionally be used with the vaporizer.

### DETAILED DESCRIPTION OF THE EXEMPLARY EMBODIMENTS OF THE INVENTION

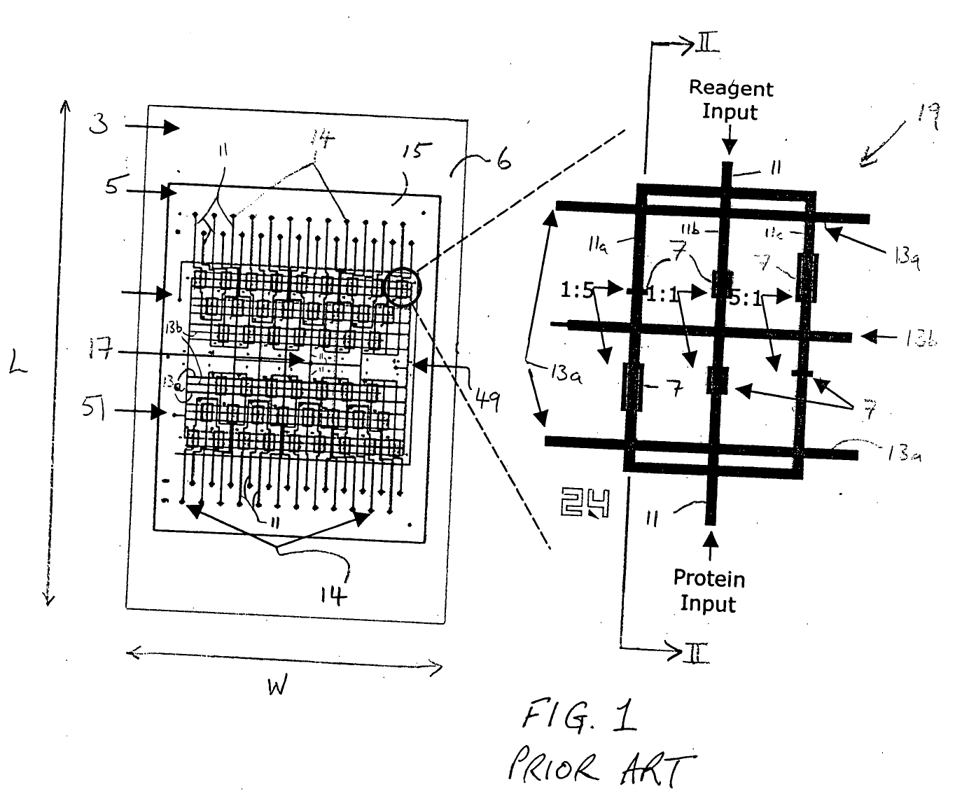

In FIGS. 1A to 3A there is shown a prior art, transparent protein crystallisation microfluidic chip 1 which is available from Fluidigm Corporation (7100 Shoreline Court, South San Francisco, Calif. 94080, U.S.A.) as part of the Topaz™ system, as detailed previously herein. The chip 1 has a glass base layer 3 on which is mounted an upper layer 5 formed from the elastomer polydimethyl siloxane (PDMS).

The glass layer has a length L of about 74-75 mm, a width W of about 50 mm and a height h1 of about 1 mm. An upper surface 6 of the glass layer 3 is provided with an orderly array of two hundred and eighty eight wells 7 therein (microwells). As evident from FIG. 1B, the volumes of the individual wells 7 vary.

The upper layer 5 is formed by the MSL™ technique, details of which are to be found on inter alia Fluidigm's website supra, and, as will be understood from FIGS. 1 and 2, has a set of microfluidic supply conduits 11 formed in a lower surface 12 thereof and a set of microfluidic valve control conduits 13a,13b formed above the supply conduits 11 and arranged orthogonally thereto. The upper layer 5 has a height h2 of about 6 mm, giving the chip a total height h3 of about 7 mm. The valve control conduits 13a,13b are spaced above the supply conduits by a distance t1 in the range of about 20-50 μm. The thickness t2 of the elastomer material above the valve control conduits 13a, 13b is about 5 mm (not shown to scale).

As evident from FIG. 1A, each supply conduit 11 is in fluid communication with one of a plurality of reagent inlets 14 arranged into sets at opposite ends of the upper layer 5. Each reagent inlet 14 extends down through the upper layer 5 from an upper surface 15 towards the lower surface 12 to intersect one of the supply conduits 11. Furthermore, each supply conduit 11 is in fluid communication with a common protein inlet 17 which extends down through the upper layer 5 in like fashion at a central position to intersect the supply conduits 11 at a convergent position thereof.

As shown in FIG. 1B, each supply conduit 11 branches into three branch sections 11a-c. The upper layer 5 is sealingly lain on the upper surface 6 of the base layer 3 so that each branch section 11a-c is disposed over two of the wells 7. In this way, each branch section 11a-c is placed in fluid communication with the wells 7. At this juncture, it is worth pointing out that the supply conduits 11 are formed as grooves in the lower surface 12 of the upper chip layer 5, but co-operate with the upper surface 6 of the base chip layer 3 to form conduits as such.

It will be further observed from FIG. 1B that each branch section 11a-c is traversed by three of the control conduits 13a,13b, the outermost control conduits 13a being hereinafter interchangeably referred to as “containment valves” and the inner or middle control conduit 13b being hereinafter interchangeably referred to as the “interfacial valve”. The interfacial valve 13b is positioned between the wells 7 in each branch section 11a-c and the containment valves 13a are located on the outside of the wells 7.

The arrangement shown in FIG. 1B forms a so-called “unit cell” 19 of the chip 1, of which there are 48 in total. The unit cells 19 communicate with a different reagent inlet 14 whereby each unit cell 19 is supplied with a different reagent, as will be detailed more fully hereinafter.

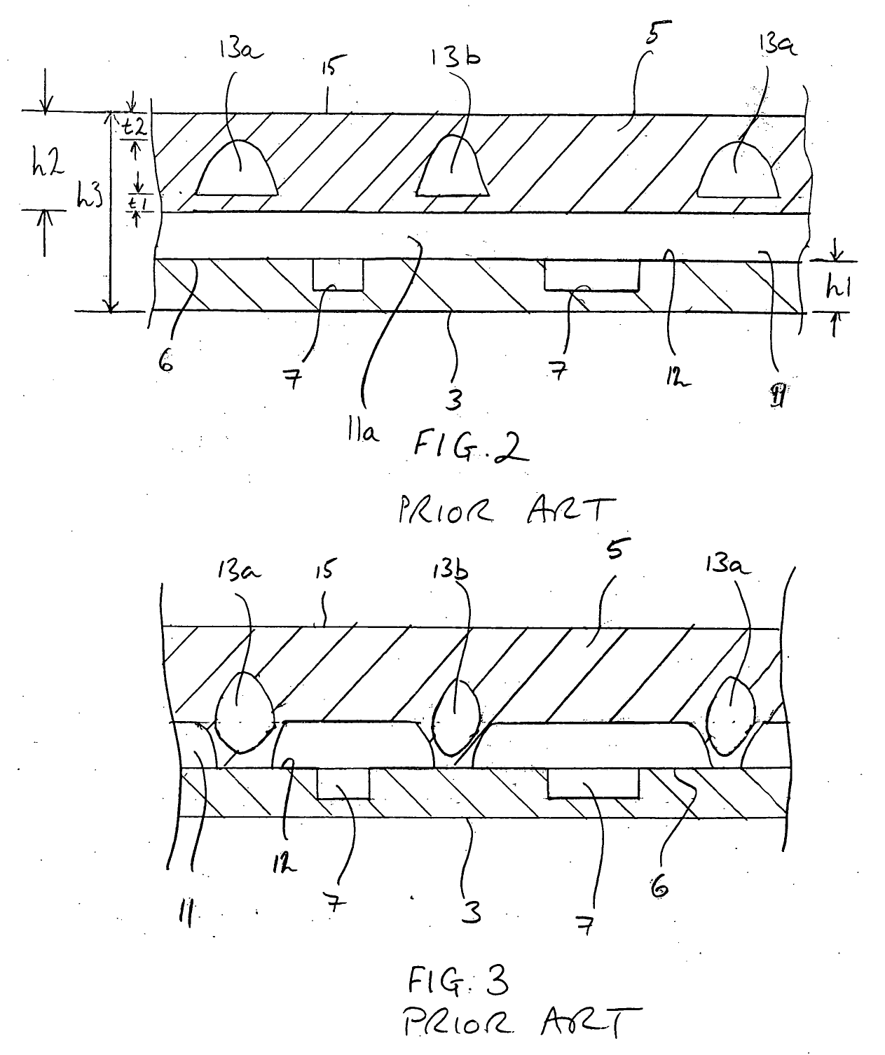

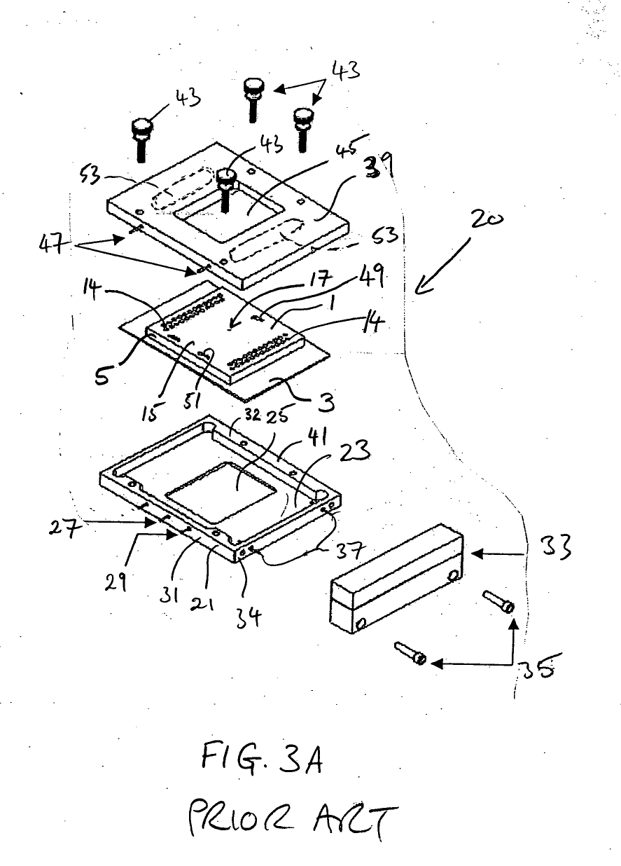

As will be understood by referring to FIGS. 2 and 3, the containment and interfacial valves 13a,13b are operable so as to be reversibly displaceable from a contracted or rest state shown in FIG. 2, in which the branch sections 11a-c of the supply conduits 11 are open, and an expanded state shown in FIG. 3, in which the branch sections 11a-c are closed by the elastomeric material at the positions at which the valves 13a,13b cross the branch sections 11a-c.

As will be discussed in more detail hereinafter, the valves 13a,13b are operable independently whereby the interfacial valves 13b are closable when the containment valves 13a are open, and vice-versa. In this way, protein and reagent are able to be metered into the unit cells 19 without coming into contact with one another and then allowed to interdiffuse (so-called “free interface diffusion”) in a sealed or closed environment.

Turning to FIG. 3A, there is shown an apparatus 20 which includes the chip 1. The apparatus 20 has a carrier frame 21 for carrying the chip 1 made from a vapour impermeable metal, e.g. aluminium. To this end, the carrier frame 21 has a recess 23 in which the base layer 3 of the chip 1 is receivable. The carrier frame 21 is also formed with an aperture 25 therethrough to enable the unit cells 19 of the chip 1 to be observed, e.g. with imaging apparatus or the like. The base layer 3 of the chip 1 covers the aperture 25 when mounted in the recess 23.

An interfacial carrier pin 27 and a containment carrier pin 29 extend through a first side 31 of a sidewall structure 32 of the carrier frame 21 into the recess 23, the purpose of which will be detailed hereinafter.

An accumulator 33 is adapted to be connected to a second side 34 of the sidewall structure 32 of the carrier frame 21 through a pair of thumb screws 35 whereby the accumulator slidingly receives a pair of fluid connectors 37. The function of the accumulator 33 will also be detailed hereinafter.

The apparatus 20 further has a transparent cover frame 39 which is able to be connected to a top side 41 of the sidewall structure 32 of the carrier frame 21 through four thumb screws 43. The cover frame 39 is also provided with a central aperture 45 which, when the cover frame 39 is connected to the carrier frame 21, enables the unit cells 19 in the chip 1 to be observable. The cover frame 39 yet further has a pair of reagent pressurisation pins 47, the purpose of which will become evident shortly.

In use, the chip 1 is firstly mounted to the carrier frame 21 to which the accumulator 33 is already fixed. An inner end (not shown) of the containment carrier pin 29 is connected to an inner end (not shown) of the nearest fluid connector 37 through a tube (not shown). Water is then pumped into the accumulator 33 via the containment carrier pin 29. An inner end (not shown) of the other fluid connector 37 is connected to a containment connector pin (not shown) which seats in a containment valve inlet 49 which is located in the upper surface 15 of the chip 1 and in fluid communication with all of the containment valves 13a. Then, with the containment connector pin out of the containment valve inlet 49, water in the accumulator 33 is pneumatically pumped so as to flow to the tip of the containment connector pin, thereby removing air from the tubing and pin. The containment connector pin is then placed in the containment valve inlet 49.

The interface valves 13b are then filled with water. In this connection, an inner end (not shown) of the interfacial carrier pin 27 is connected to tubing (not shown) on the opposite end of which is fitted an interfacial connector pin (not shown). Water is then pumped into the tubing via the interfacial carrier pin 27 until it is at the tip of the interfacial connector pin, thereby removing air from the tubing and pin. The interfacial connector pin is then inserted into an interfacial valve inlet 51 in the upper surface 15 of the chip 1 which is in fluid communication with each interfacial valve 13b. The interfacial carrier pin 27 is then connected to a pneumatic pressure source at 15 psi above atmospheric pressure so as to cause the water to be filled into each interfacial valve 13b. In this way, the interfacial valves 13b are pressurised so as to close the supply conduits 11 in-between the wells 7 of each branch section 11a-c. At this stage, the containment valves 13a are open.

Next, a protein solution (5 μL), such as bovine serum albumin (BSA), is pipetted into the protein inlet 17 and pneumatically pressurised into the supply conduits 11 of the chip 1 at a pressure of 5 psi above atmospheric pressure. In this way, the protein flows to blind-fill the branch sections 11a-c of each unit cell 19 on one side of the closed interfacial valve 13b.

A different crystallisation reagent is then pipetted into each reagent inlet 14. The cover frame 39 is then fixed to the carrier frame 21 and the reagent pressurisation pins 47 connected to a pneumatic pressure source. When mounted to the carrier frame 21, the cover frame 39 is in bearing relation on the upper surface 15 of the chip 1 so as to bring a pair of recesses 53 (FIG. 3A) formed in the underside of the cover frame 39 into respective registration with the sets of reagent inlets 14. The recesses 53 each communicate with one of the reagent pressurisation pins 47 and form a sealed cavity above the sets of reagent inlets 14. The pneumatic pressure source is then operated to pressurise the reagent inlets 14 at 5 psi above atmospheric pressure to cause each unit cell 19 to be blind-filled with a different crystallisation reagent on the opposite side of the interfacial valve 13b from the protein.

It will be gathered that the protein is the same in each unit cell 19, but that the reagent from unit cell-to-unit cell differs. Moreover, the protein will be reacted with each reagent at three different ratios due to the different volumes of the wells 7 in the branch sections 11a-c in the unit cells 19. More particularly, the ratio of protein to each reagent will be 5:1, 1:1 and 1:5.

Once the protein and reagents have been metered into the branch sections 11a-c of the unit cells 19, the containment valves 13a are closed by connecting the containment carrier pin 29 to a pneumatic pressure source and pressurising this at 15 psi above atmospheric pressure to cause the water in the accumulator 33 and tubing extending to the containment connector pin in the containment valve inlet 49 to fill the containment valves 13a and close the branch sections 11a-c of the supply conduits 11. The interfacial valves 13b are then opened by removing the pneumatic pressure applied to the water therein.

In this way, closed cells are formed in each unit cell 19 between the closed containment valves 13a in each branch section 11a-c. The protein and crystallisation reagents can then diffuse towards the opposite wells 7.

The chip 1 is then stored after the pressure source attached to the containment carrier pin 29 is removed and a new pressurisation source connected thereto. The accumulator 33 acts to keep the containment valves 13a shut during this transfer.

As mentioned previously herein, the typical molecular size difference between the protein and reagent means that while it typically only takes a matter of a few hours for the reagent to diffuse from the well 7 on its side of the closed cell to the well 7 on the protein side, it will take the protein days or weeks to diffuse from the well 7 on its side to the well 7 on the reagent side. It is therefore important to keep the interfacial valve 13b open long enough for the protein to diffuse from its well 7 to the reagent well 7. The need to keep the interfacial valve 13b open also holds true for slow diffusing, large molecular weight reagents, such as PEGs which have molecular weights in the range of 400-10,000 g/mol. The interfacial valve 13b needs to keep open sufficiently long to allow diffusion of the reagents and proteins until an equilibrium state is reached in the closed cell.

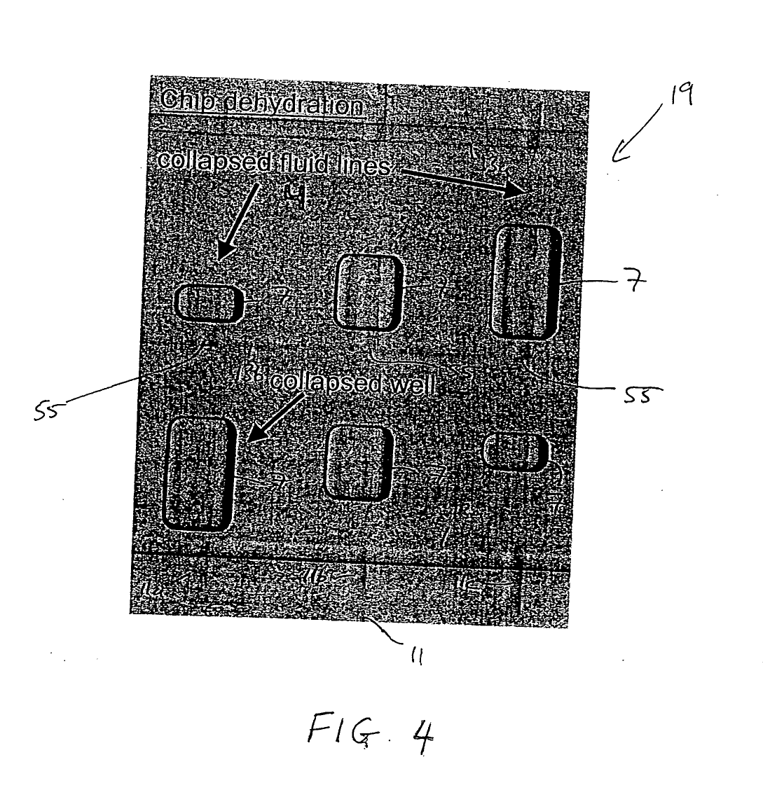

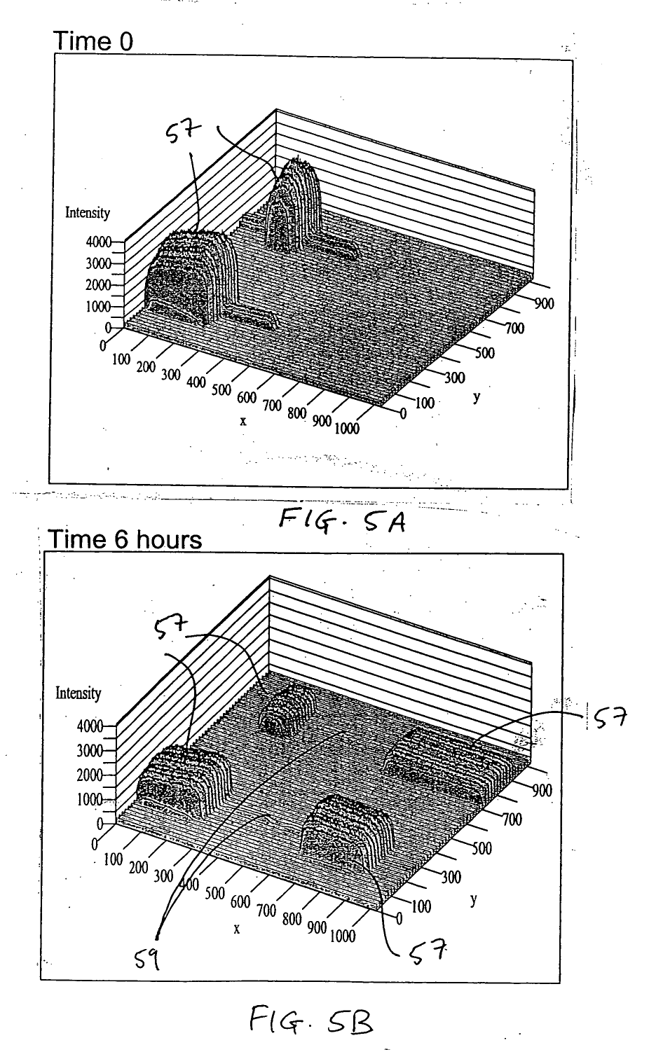

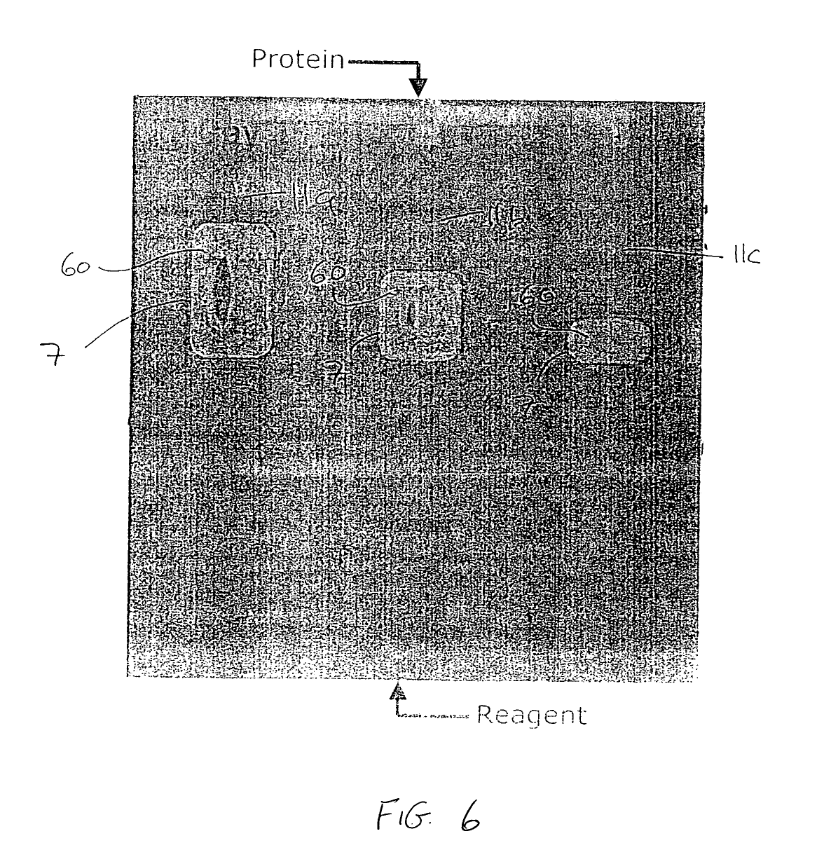

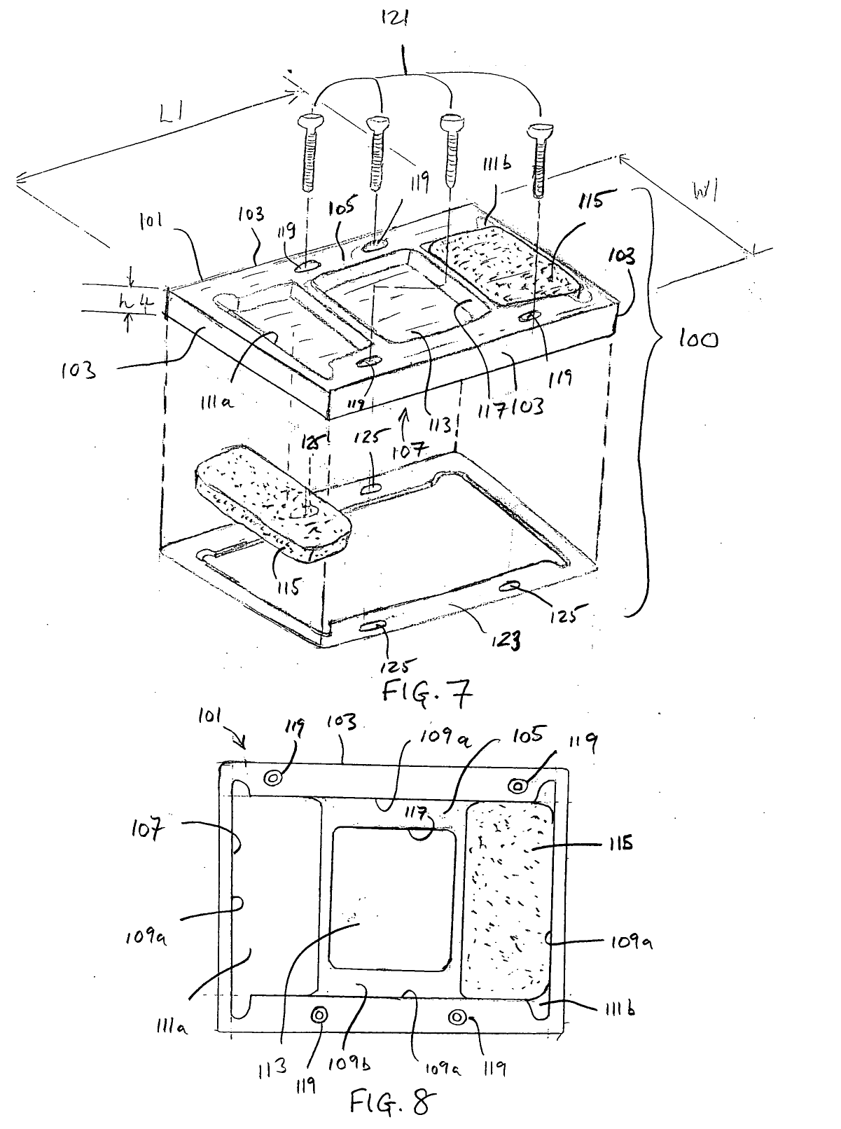

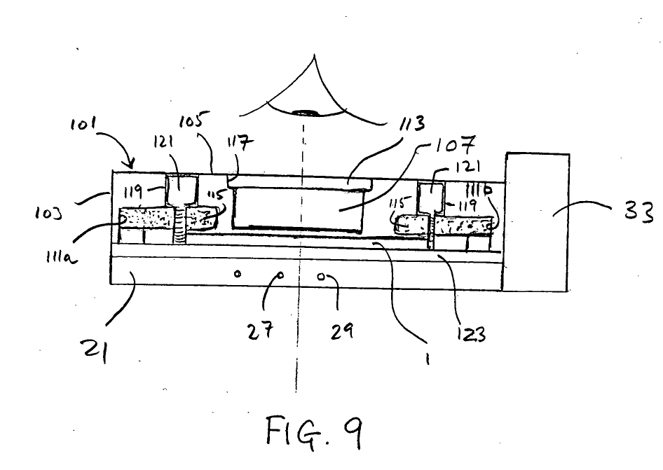

However, it has been observed by the Applicant that the interfacial valves 13b spontaneously re-close after only a few hours of the crystallisation reaction. In this regard, reference is made to FIGS. 4 to 6.

FIG. 4 is a photograph showing one of the unit cells 19 of the chip 1 in which the interfacial valves 13b have erroneously shut the branch sections 11a-c at the intersection points 55 after only a period of 4 hours into the protein crystallisation reaction process, i.e. 4 hours after the interfacial valve 13b was initially opened for inter-diffusion of the reactants. In this regard, it will be noted that the branch sections 11a-c are not wholly visible because they have collapsed against the upper surface 6 of the glass base layer 3 of the chip 1.

FIG. 5 is a graph representing the diffusion of a crystallisation reagent 57 (PBS) in the chip 1 which contains a fluorescent agent (Fluorocein). FIG. 5A shows the crystallisation reagent at time zero, i.e. before the interfacial valve 13b is opened by removing the pressure therein. FIG. 5B shows that 6 hours after opening the interfacial valve 13b a proportion of the crystallisation reagent 57 has diffused from the well 7 on its starting side of the closed cell (left-hand side of graph) to the well 7 on the protein side (right-hand side), but that there is no crystallisation reagent 57 at the mid-point 59 between the two wells 7. This is because the interfacial valve 13b has spontaneously shut preventing further diffusion of the crystallisation reagent from its side of the branch section to the protein side.

FIG. 6 shows how far a protein (BSA) 60 tagged with a fluorescent agent (Alexa 488) has diffused in the chip 1 after 10 days. As will be seen, the protein 60 is still on the same side of the branch sections 11a-c it started on due to the closure of the interfacial valve 13b after only a few hours. In fact, nearly all of the protein is still in its well 7.

The Applicant has determined that the spontaneous re-closing of the interfacial valve 13b is due to the chip 1 dehydrating. In other words, once the closed cells are formed in the branch sections 11a-c, water from the protein solution and/or reagent evaporates from the apparatus 20 due to the vapour permeability of the upper layer 5 of the chip 1 and the fact that the chip 1 is not housed in a sealed enclosure, e.g. the water vapour can escape from inter alia the aperture 45 in the cover frame 39.

As the evaporation goes unchecked, a negative pressure is created in the closed cells whereby the interfacial valve 13b again is at a higher pressure than in the branch sections 11a-c leading to the interfacial valve 13b re-closing the branch sections 11a-c. The dehydration and resultant negative pressure also leads to the branch sections 11a-c collapsing, as seen in FIG. 4.

In FIGS. 7 to 9 there is shown a vaporizer unit 100 in accordance with the present invention adapted to be mounted to the carrier frame 21 (FIG. 3A) which carries the chip 1 to solve the problem of chip dehydration.

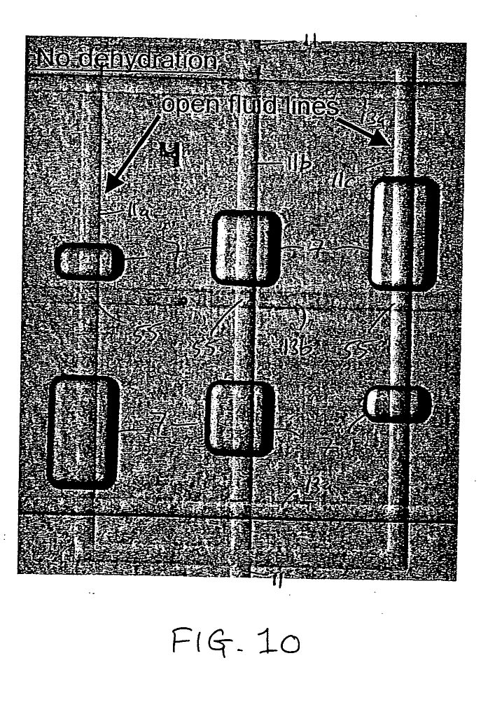

The vaporizer unit 100 has a transparent, vapour impermeable lid or housing 101 of rectangular shape and defined by an endless sidewall structure 103 and a roof 105 which caps the sidewall structure 103. The housing has a length L1 of about 80-81 mm, a width W1 of about 64 mm and a height h4 of about 11-12 mm. As will be understood from FIGS. 8 and 9, the housing 101 provides an enclosed cavity or inner volume 107 bounded by an inner surface 109a, 109b of the sidewall structure 103 and the roof 105, respectively.

The inner surface 109b of the roof 105 is provided with two recesses 111a,111b located on either side of a glass insert or window 113 in the roof 105. Releasably mountable in each recess 111a,111b is an absorbent pad 115. For better understanding, FIGS. 7 and 8 only show one pad 115 in its associated recess 111b.

The housing 101 is moulded from Perspex® with an aperture 117 in the roof 105 for the glass window 113 to be sealingly secured in. The glass window 113 enables the unit cells 19 of the chip 1 to be observed therethrough or for analysis signals, e.g. light or other electromagnetic radiation, to be transmitted through the chip 1 via the housing window 113 and the aperture 25 in the carrier frame 21 (FIG. 3A).

The sidewall structure 103 of the housing 101 is sized and shaped to match the top side 41 of the sidewall structure 32 of the carrier frame 21 for the chip 1 so as to enable the housing 101 to be mounted to the top side 41 of the carrier frame 21. Moreover, the housing 101 has bores 119 through the sidewall structure 103 to enable the housing 101 to be screw retained to the carrier frame 21 with thumb screws 121, as shown in FIG. 9.

In addition to the housing 101, the vaporizer unit 100 has a ring-like gasket 123 of a vapour impermeable, plastics material, for instance silicone rubber, with a plan profile which matches that of the underplan profile of the sidewall structure 103 of the housing 101. In addition, the gasket 123 is provided with apertures 125 for the passage of the thumb screws 121 therethrough.

As shown in FIG. 9, when the vaporizer unit 100 is releasably connected to the carrier frame 21, the gasket 123 forms a seal at the joint between the sidewall structure 103 and the carrier frame 21.

A sealant is used so that the aperture 25 in the carrier frame 21 is sealingly closed-off, in use, by the glass base layer 3 of the microfluidic chip 1. Suitable sealants are silicone sealant, grease or mineral oil. In an alternative embodiment, the carrier frame 21 could be modified so that a window is sealingly secured in the aperture 25, as in the housing 101.

Noting this, and recalling that the carrier frame 21 and housing 101 of the vaporizer unit 100 are vapour impermeable, it will be understood that when the vaporizer unit 100 is fixed to the carrier frame 21 with a loaded chip 1 mounted thereon, a hermetically sealed enclosure is provided around the chip 1. Thus, the water vapour escaping from the closed cells is retained in the local environment of the chip 1. Moreover, the absorbent pads 115 are soaked with water so that they create water vapour in the enclosure. In other words, the chip 1 is housed in an equivalent of a cigar humidor.

In use, the chip 1 is loaded onto the carrier frame 21 with the interface of the glass base layer 3 and the aperture 25 being sealed with sealant. The absorbent pads 115 are then wetted with de-ionised water with the excess removed by shaking. The pads 115 are then loaded into the housing 101 and the housing 101 screw retained on the carrier frame 21 through the gasket 123. This assembly is then left for 1-2 days to allow the chip 1 to hydrate. In this regard, the inner volume of the enclosure formed by the housing 101 and the carrier frame 21 is a hermetically sealed volume and the inner volume is able to become saturated with water vapour, e.g. 100% Relative Humidity (RH) is achieved if the absorbent pads are soaked with a sufficient volume of water.

The housing 101 is then removed and the chip 1 prepared for, and metered with, protein and reagent in the same manner as previously described for the prior art apparatus 20, i.e. with the interfacial valves 13b shut. The cover frame 39 is then detached from the carrier frame 21 and replaced with a pre-wetted vaporizer unit 100. The containment valves 13a are then shut and the interfacial valves 13b opened.

As will be gathered by the skilled reader, the vaporizer unit 100 keeps the chip hydrated through the protein crystallisation reaction. Consequently, the interfacial valve 13b is maintained open throughout thereby allowing time for the protein to diffuse to the reagent side of the closed cells and/or vice-versa.

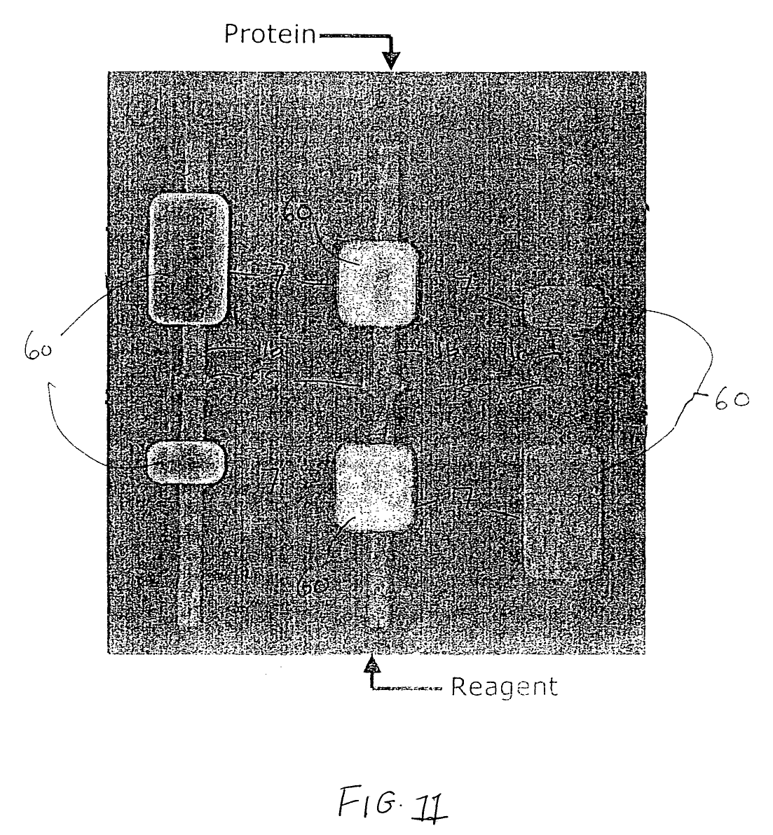

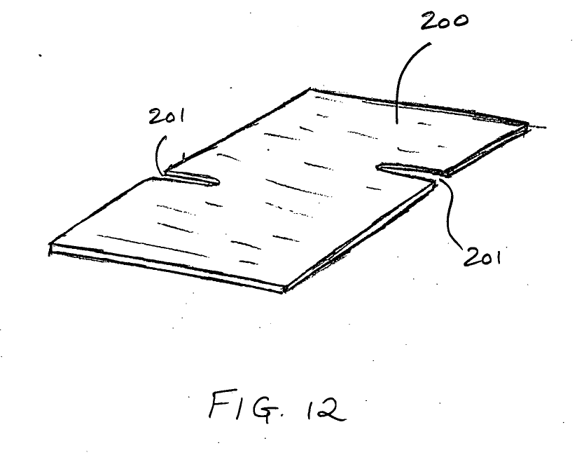

By way of demonstrating the efficacy of the vaporizer unit 100 in hydrating the chip 1 to prevent the spontaneous re-closing of the interfacial valve 13b during the crystallisation process, reference is now made to FIGS. 10 and 11.

FIG. 10 is a photograph showing one of the unit cells 19 of the chip 1 after 4 hours into the same protein crystallisation process illustrated in FIG. 4, but carried out with the chip 1 housed in the vaporizer unit 100. Comparison of this photograph with FIG. 4 clearly shows the beneficial effect of the vaporizer unit 100. It can be seen that the branch sections 11a-c of the supply conduit 11 are well defined, i.e. not collapsed. The junctions 55 of the branch sections 11a-c with the interfacial valve 13b are also still open.

FIG. 11 shows the extent of diffusion of a protein solution (BSA) after 10 days storage of the chip 1 housed in the vaporizer unit 100. To this end, the protein was tagged with a fluorescent dye (Alexa 488). As will be seen, particularly by comparison of FIG. 11 with FIG. 6, the protein has migrated from the well 7 on its starting side of the closed cell to the reagent well 7. Moreover, it is evident that protein is located in the branch sections 11a-c, including its junction 55 with the interfacial valve 13b. Again, this shows that the vaporizer unit 100 acts to keep the chip 1 hydrated and hence the interfacial valve 13b open.

While the vaporizer unit 100 is successful in keeping open the interfacial valve 13b, the Applicant has identified that with certain aqueous protein crystallisation reagents it is possible to over-saturate or over-hydrate the chip 1 with the vaporizer unit 100 when a relative humidity of 100% is produced therein. In other words, the rate of egress of water vapour from the branch sections 11a-c of the supply conduit 11 is less than the rate of ingress of water vapour thereinto. This leads to an increase in pressure in one or more of the branch sections 11a-c which can force open one and/or other of the associated containment valves 13a until the pressure reduces whereupon the containment valve(s) 13a re-close. This is known as “burping” and is problematic in the sense of enabling escape of some of the protein-reagent mixture.

To address the issue of burping, it has been recognised that protein crystallisation reagents fall into one of two different sets, a first set in which use of the vaporizer unit 100 to give a 100% RH keeps open the interfacial valve 13b without the burping of the containment valves 13a, and a second set which needs a reduced level of RH about the chip 1 to prevent the burping whilst still keeping open the interfacial valve 13b. For the second set of reagents, it has been found that maintaining a lower RH level, preferably 95%, or substantially 95%, with the vaporizer unit 100 works. This may be achieved by soaking a reduced amount of water onto the absorbent pads 115, e.g. 60 μL.

With this in mind, in use it is preferable to load the chip 1 with a plurality of different crystallisation reagents which either all come from one reagent set or the other so that the vaporizer unit 100 can then be operated to control the RH level to that required for that particular reagent set.

An example of a reagent which falls into the 100% RH set is, of course, PBS, as described previously. Examples of reagents falling into the lower RH set are 2 molar NaCl (sodium chloride) and 2 molar NH₄SO₄ (ammonium sulphate). These are hygroscopic reagents, hence, probably, the need for the reduced RH level.

A further improvement in the control of the hydration of the chip 1 can be achieved through use of a liquid other than water in the containment and interfacial valves 13a, 13b, for instance a liquid which has a slow diffusion rate in the PDMS of the chip 1 and, preferably, which is inert to the protein crystallisation reaction. Preferably, the liquid is a non-aqueous or substantially non-aqueous liquid, for example a fluorinated silicone oil, for instance MED-400 fluorinated silicone oil 100 centipoise (Polymer Systems Technology, High Wycombe, Buckinghamshire, United Kingdom).

In FIG. 12 there is shown a glass cover 200 which can be optionally used in the vaporizer unit 100. In use, the glass cover 200 is lain over the upper surface 15 of the chip 1 to cover its whole extent. The glass cover 200 is then enclosed by the housing 101. The glass cover 200 has a pair of cut-outs 201 which, in use, leave the containment and interfacial valve inlets 49, 51 in the upper surface 15 of the chip 1 uncovered, thereby enabling the respective connector pins to be inserted thereinto.

The glass cover 200 acts as a barrier to water vapour evaporating from the upper surface 15 of the chip 1. It would typically be put in place 3 days or so after the start of the crystallisation process. In other words, the housing 101 would be removed from the carrier frame 21, the glass cover 200 lain over the chip surface 15, and the housing re-secured to the carrier frame 21. The glass cover 200 helps slow the hydration process and prevent over-hydration of the chip 1.

It will be seen that the exemplary embodiments of the present invention provide a means which prevents the chip valve mechanism from spontaneously re-closing the supply conduit at the intermediate position during the interaction state of the chip structure. Not only does this ensure that the reactants can diffuse to completion, but it also enables the valve mechanism to be operated to periodically close the supply conduit at the intermediate position during the interaction state to regulate the diffusion of the fluid materials from the starting side of the closed cell to the opposite side of the closed cell.

For the avoidance of doubt, the present invention is not limited to the embodiments hereinabove described with reference to the accompanying FIGURES of drawings, but encompasses all variations, modifications and alternative embodiments within the scope of the appended claims. As an example, the invention is not limited to the case of compensating for water evaporation from the chip. The evaporate from the fluid material(s) in the chip may be non-aqueous, but still result in the effect of spontaneous re-closure of the supply conduit if gone unchecked. The invention is apt to solve this problem too. Moreover, the embodiments herein described may be modified or varied to include features mentioned in the claims and the statements in the section entitled ‘Summary of the Invention’. Additionally, the use of terms such as “substantially”, “about” and the like in reference to a parameter or property is meant to include the exact value of the parameter or that exact property.

1. An apparatus for performing microchemistry having:—
(a) a vapour permeable microfluidic chip structure having:—
a supply conduit enclosed in the chip structure having first and second opposed ends to enable first and second fluid materials to interact by flowing the first and second fluid materials towards one another from the opposed ends of the supply conduit, and
(b) a valve mechanism in the chip structure operable to open and close the supply conduit at an intermediate position located between the first and second ends thereof whereby the chip structure is sequentially movable from a filling state in which the intermediate position is closed to enable the fluid materials to be blind-filled in the supply conduit on opposed sides of the intermediate position and an interaction state in which the intermediate position is open to enable the fluid materials to interact; and
(c) a vaporizer for forming a vaporous environment about the chip structure to compensate for evaporation of the fluid materials from the supply conduit of the chip structure in the interaction state.

2. The apparatus of claim 1, wherein the valve mechanism is further operable to form a closed cell in the supply conduit which includes the intermediate position and in which the fluid materials interact in the interaction state and the vaporizer is adapted in use to compensate for evaporation of the fluid materials from the closed cell in the interaction state.

3. The apparatus of claim 1, wherein the valve mechanism in the chip structure is operable to open and close the supply conduit at first and second end positions, on opposed sides of the intermediate position, to form therebetween a closed cell in the supply conduit whereby in the filling state the end positions are open and in the interaction state the end positions are closed to enable the fluid materials to interact in the closed cell.

4. The apparatus of claim 1 in which the valve mechanism is such that it would operate to re-close the supply conduit at the intermediate position in the interaction state if the evaporation from the chip structure was not compensated for.

5. The apparatus of claim 1 in which the vaporizer includes a vapour generating mechanism in the form of one or more absorbent members for absorbing a vaporizable liquid thereon.

6. The apparatus of claim 1 wherein the vaporizer includes at least a part of an enclosure in which the chip structure is enclosable and further has a vapour generating mechanism for generating a vapour inside the enclosure.

7. The apparatus of claim 6 in which the vapour generating mechanism is in the form of one or more absorbent members for absorbing a vaporizable liquid thereon.

8. The apparatus of claim 6 wherein the at least a part of the enclosure is a housing which carries the vapour generating mechanism.

9. The apparatus of claim 6 in which the at least a part of the enclosure includes a window which, when the chip structure is received in the enclosure, registers with the chip structure so that the supply conduit is observable therethrough.

10. The apparatus of claim 6 wherein the valve mechanism is further operable to form a closed cell in the supply conduit which includes the intermediate position and in which the fluid materials interact in the interaction state and the vaporizer is adapted in use to compensate for evaporation of the fluid materials from the closed cell in the interaction state, and in which the at least a part of the enclosure includes a window which, when the chip structure is received in the enclosure, registers with the chip structure so that the closed cell is observable therethrough.

11. The apparatus of claim 6 wherein the enclosure has a carrier on which the chip structure is supported.

12. The apparatus of claim 8 in which the housing of the enclosure is adapted to sit on the carrier.

13. The apparatus of claim 12 in which the housing is sealingly seatable on the carrier.

14. The apparatus of claim 13 in which a seal is provided to sealingly engage the interfacing surfaces of the carrier and housing.

15. The apparatus of claim 6 in which the enclosure is adapted to form a sealed environment about the chip structure, or a substantially sealed environment thereabout.

16. The apparatus of claim 1 in which the valve mechanism has a valve in the form of a control conduit enclosed in the chip structure to cross the supply conduit in spaced relation thereto at the intermediate position, the supply and control conduits are so constructed and arranged that the valve mechanism is able to be sequentially operated to (i) close the supply conduit for the filling state by pressurisation of the control conduit to a pressure which is greater than that in the supply conduit to cause the control conduit to pinch closed the supply conduit at the intermediate position, and (ii) open the supply conduit for the interaction state by a reduction of the pressure in the control conduit relative to the pressure in the supply conduit, and wherein the vaporizer is adapted in use to compensate for evaporation from the supply conduit in the interaction state such that the pressure difference between the supply and control conduits is not such as to cause the control conduit to re-close the supply conduit.

17. An apparatus for performing microchemistry having:—
(a) a vapour permeable microfluidic chip structure having:—
a supply conduit enclosed in the chip structure having first and second opposed ends to enable first and second fluid materials to interact by flowing the first and second fluid materials towards one another from the opposed ends of the supply conduit, and
a valve mechanism in the chip structure operable to open and close the supply conduit at an intermediate position located between the first and second ends thereof whereby the chip structure is sequentially movable from a filling state in which the intermediate position is closed to enable the fluid materials to be blind-filled in the supply conduit on opposed sides of the intermediate position and an interaction state in which the intermediate position is open to enable the fluid materials to interact in the supply conduit,
wherein the valve mechanism is such that it operates to re-close the supply conduit at the intermediate position in the interaction state if evaporation from the supply conduit of the chip structure is not compensated for; and
(b) a compensation mechanism for compensating for evaporation from the supply conduit of the chip structure to prevent re-closure of the supply conduit at the intermediate position in the interaction state of the chip structure.

18. The apparatus of claim 17, wherein the valve mechanism is further operable to form a closed cell in the supply conduit which includes the intermediate position and in which the fluid materials interact in the interaction state, wherein the valve mechanism is such that it operates to re-close the supply conduit at the intermediate position in the interaction state if evaporation from the closed cell of the chip structure is not compensated for, and wherein the compensation mechanism is adapted in use to compensate for evaporation of the fluid materials from the closed cell to prevent re-closure of the supply conduit.

19. The apparatus of claim 17, wherein the valve mechanism in the chip structure is operable to open and close the supply conduit at first and second end positions, on opposed sides of the intermediate position, to form therebetween a closed cell in the supply conduit whereby in the filling state the end positions are open and in the interaction state the end positions are closed to enable the fluid materials to interact in the closed cell.

20. The apparatus of claim 17 in which the valve mechanism has a valve in the form of a control conduit enclosed in the chip structure to cross the supply conduit in spaced relation thereto at the intermediate position, the supply and control conduits are so constructed and arranged that the valve mechanism is able to be sequentially operated to (i) close the supply conduit for the filling state by pressurisation of the control conduit to a pressure which is greater than that in the supply conduit to cause the control conduit to pinch closed the supply conduit at the intermediate position, and (ii) open the supply conduit for the interaction state by a reduction of the pressure in the control conduit relative to the pressure in the supply conduit, and wherein the compensation mechanism is adapted in use to compensate for evaporation from the supply conduit in the interaction state such that the pressure difference between the supply and control conduits is not such as to cause the control conduit to re-close the supply conduit.

21. The apparatus of claim 17 in which the valve mechanism has a valve in the form of a control conduit enclosed in the chip structure to cross the supply conduit in spaced relation thereto at the intermediate position, the supply and control conduits are so constructed and arranged that the control conduit is able to expand at the intermediate position sufficiently to cause the supply conduit to close thereat when the pressure in the control conduit is greater than that in the supply conduit by a predetermined pressure difference, and the compensation mechanism is adapted to maintain the pressure difference between the control conduit and the supply conduit below the predetermined pressure difference in the interaction state of the chip.

22. The apparatus of claim 17 in which the compensation mechanism is a vaporizer for forming a vaporous environment about the chip structure to compensate for evaporation from the supply conduit of the chip structure in the interaction state.

23. The apparatus of claim 16 in which the control conduit is hydraulically pressurizable to selectively open and close the supply conduit.

24. A vaporizer adapted for use with a microfluidic chip structure having a casing structure for placing over the chip structure and a vapour generating mechanism carried by the casing structure for generating a vaporous environment inside the casing about the chip.

25. The vaporizer of claim 24 in which the vapour generating mechanism is mounted on an internal surface of the casing which, in use, faces the chip structure.

26. The vaporizer of claim 24 wherein the vapour generating mechanism is releasably carriable on the casing structure.

27. The vaporizer of claim 24 in which the vapour generating mechanism is an absorbent structure.

28. The vaporizer of claim 24 in which the casing structure includes a window section which, in use, registers with the chip for viewing thereof.

29. The vaporizer of claim 24 in which the casing structure forms at least a part of an enclosure adapted to enclose the chip.

30. The vaporizer of claim 29 in which the casing structure is adapted to sealingly enclose the chip.

31. The vaporizer of claim 30 in which the casing structure has a lid part and a carrier part on which the lid part is seatable, and a seal for sealing the interface between the lid and carrier parts.

32. The vaporizer of claim 31 in which the lid part carries the vapour generating mechanism.

33. The vaporizer of claim 24 in which the microfluidic chip structure is a vapour permeable microfluidic chip structure having:—
a supply conduit enclosed in the chip structure having first and second opposed ends to enable first and second fluid materials to interact by flowing the first and second fluid materials towards one another from the opposed ends of the supply conduit, and
a valve mechanism in the chip structure operable to open and close the supply conduit at an intermediate position located between the first and second ends thereof whereby the chip structure is sequentially movable from a filling state in which the intermediate position is closed to enable the fluid materials to be blind-filled in the supply conduit on opposed sides of the intermediate position and an interaction state in which the intermediate position is open to enable the fluid materials to interact.

34. In combination, the vaporizer according to claim 24 and a microfluidic chip structure over which the casing structure is able to be placed.

35. The combination of claim 34 in which the microfluidic chip structure is adapted for use in protein crystallisation.

36. The combination of claim 34 in which the vapour generating means generates water vapour.

37. The combination of claim 36 in which the vapour generating mechanism is adapted in use to achieve a relative humidity (RH) in the range of 90-100% about the chip structure.

38. A method of interacting first and second fluid materials comprising the steps of:—
providing a vapour permeable microfluidic chip structure having a supply conduit and a valve mechanism to selectively close off the supply conduit at an intermediate position;
operating the valve mechanism to close the supply conduit at the intermediate position thereof;
blind filling the supply conduit with the first and second fluid materials on opposite sides of the intermediate position;
operating the valve mechanism to open the supply conduit at the intermediate position to cause the first and second fluid materials to interact; and
forming a vaporous environment about the chip during the interaction of the fluid materials.

39. The method of claim 38 in which the valve mechanism is adapted to form a closed cell in the supply conduit which includes the intermediate position and the valve mechanism is operated so that when the intermediate position is opened the fluid materials interact in the closed cell.

40. The method of claim 38 in which the valve mechanism is such that it will re-close the supply conduit at the intermediate position if evaporation of the fluid materials from the supply conduit during the interaction thereof is not compensated for and the vapourous environment compensates for such evaporation to prevent the valve mechanism re-closing at the intermediate position.

41. The method of claim 38 in which the interaction is a protein crystallisation reaction.

42. The method of claim 41 in which the first fluid material is a protein solution and the second fluid material is a crystallisation reagent.

43. The method of claim 38 wherein the vaporous environment is formed by a vaporizer adapted for use with a microfluidic chip structure having a casing structure for placing over the chip structure and a vapour generating mechanism carried by the casing structure for generating a vaporous environment inside the casing about the chip.

44. The method of claim 38 including the step of decreasing the level of saturation in the vaporous environment after the first and second fluid materials have interacted for a duration sufficient to reach an equilibrium state.

45. The method of claim 38 in which the vaporous environment is a saturated environment for a predetermined period after opening the supply conduit.

46. The method of claim 38 wherein the vaporous environment is a sealed environment.

47. The method of claim 38 in which the vapour is water vapour and the vapourous environment is maintained in the range of 90-100% Relative Humidity (RH).

48. The method of claim 38 in which at least one of the fluid materials is an aqueous fluid.

49. The method of claim 42 in which at least one of the protein and reagent is in an aqueous solution.

50. The method of claim 49 in which the RH level is reduced after the interaction of the protein and reagent has reached an equilibrium state or has finished.

51. The method of claim 38 in which the chip structure is saturated with the vapour material prior to blind filling the supply conduit with the fluid materials.

52. A method of protein crystallisation comprising the steps of providing a vapour permeable, microfluidic, protein crystallisation chip structure having a supply conduit enclosed therein and a valve mechanism which is operable to close the supply conduit at an intermediate position thereof, closing the supply conduit at the intermediate position, blind filling the supply conduit with a protein fluid on one side of the intermediate position and a crystallisation reagent fluid on the opposite side of the intermediate position, operating the valve mechanism to open the supply conduit at the intermediate position and compensating for evaporation of fluid from the supply conduit to prevent the valve mechanism re-closing the supply conduit at the intermediate position for a duration sufficient to allow the fluids to interact to reach an equilibrium state.

53-55. (canceled)
